(19) United States
(12) Patent Application Publication
(10) Pub. No.: US 2011/0137735 A1
(43) Pub. Date: Jun. 9, 2011

(54) USES OF MULTIPLE LOCATION PARAMETERS, POLYGONAL EXCLUSION AND INCLUSION ZONES, AND OTHER INPUT DATA IN LOCATION-COUPLED INFORMATION SELECTION

(75) Inventors: ZEENAT JETHA, North Vancouver (CA); David J. P. Baar, Vancouver (CA); Jamie Chong, North Vancouver (CA); Vincent Ting, Vancouver (CA); Aaron Drake, Port Moody (CA); Keith Ippel, Richmond (CA)

(73) Assignee: Lat49 Media Inc., Vancouver (CA)

(21) Appl. No.: 12/846,662

(22) Filed: Jul. 29, 2010

Related U.S. Application Data
(60) Provisional application No. 61/230,697, filed on Aug. 1, 2009.

(51) Int. Cl. G06Q 30/00

(52) U.S. Cl. 705/14.73

(57) ABSTRACT

A method for presenting advertisement images on a display screen, comprising: subdividing a map image into a plurality of geographic regions; associating an advertisement image with a region of the plurality of geographic regions; receiving a signal indicative of a group of regions of the plurality of geographic regions; receiving a signal indicative of a region-of-interest, the region-of-interest corresponding to at least one region of the plurality of geographic regions; determining whether the region and the region-of-interest are included in the group of regions, and if so, generating a presentation of the advertisement image; and, displaying the presentation on the display screen.

This application claims priority from U.S. Provisional Patent Application No. 61/230,697, filed Aug. 1, 2009, and incorporated herein by reference.

### FIELD OF THE INVENTION

This invention relates to the field of geographic positioning and online advertising, and more specifically, to a method and system for location-coupled information selection.

### BACKGROUND OF THE INVENTION

The growth of the Internet and online map presentation technologies has resulted in broad availability of online and interactive presentation of maps and geographically relevant photographic images. A complementary trend has been growing availability of portable implementations of locating technologies via mobile Global Positioning System (“GPS”) capabilities and network-assisted GPS in modern mobile devices (e.g., cellular telephones). Furthermore, in many cases of Internet usage, a user's location can be established to varying degrees of confidence by other means such as Internet Protocol (“IP”) to location lookup. In addition, other location or location-related information may be known about a given user, such as home or office location, based on user profile in the case of a logged-in user or from Internet service provider records. The end result is a rich set of data related to multiple locations for any given Internet user and Internet usage session, including one or more locations of interest to the user (as expressed, for example, by a current map view requested by the user) as well as the actual location of the user himself and other locations related to the user (e.g., home address, office address, etc.).

However, applications running on current data processing systems (e.g., mobile devices, etc.) have yet to take full advantage of available positioning technology to select information for presentation to users based on or coupled to location.

A need therefore exists for an improved method and system for location-coupled information selection. Accordingly, a solution that addresses, at least in part, the above and other shortcomings is desired.

### SUMMARY OF THE INVENTION

According to one aspect of the invention, there is provided a method for presenting advertisement images on a display screen, comprising: subdividing a map image into a plurality of geographic regions; associating an advertisement image with a region of the plurality of geographic regions; receiving a signal indicative of a group of regions of the plurality of geographic regions; receiving a signal indicative of a region-of-interest, the region-of-interest corresponding to at least one region of the plurality of geographic regions; determining whether the region and the region-of-interest are included in the group of regions, and if so, generating a presentation of the advertisement image; and, displaying the presentation on the display screen. In the above method, the group of regions may be defined by at least one polygon presented on the map image.

According to another aspect of the invention, there is provided a method for location-coupled information selection using multiple location parameters, polygonal exclusion and inclusion zones, and other input data.

In accordance with further aspects of the present invention there is provided an apparatus such as a data processing system or a mobile device, a method for adapting these, as well as articles of manufacture such as a computer readable medium (or product) having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is a screen capture illustrating an advertisement presentation in accordance with an embodiment of the invention;

FIG. 3 is a screen capture illustrating a first case where Lᵤ is located inside a polygon P in accordance with an embodiment of the invention;

FIG. 4 is a screen capture illustrating a second case where Lᵢ is located inside a polygon P in accordance with an embodiment of the invention;

FIG. 5 is a screen capture illustrating a third case where Lᵢ is located outside a polygon P in accordance with an embodiment of the invention;

FIG. 6 is a screen capture illustrating a fourth case where Lᵤ is located outside a polygon P in accordance with an embodiment of the invention;

FIG. 7 is a screen capture illustrating a fifth case where Lᵢ is located inside a polygon P with excluded areas in accordance with an embodiment of the invention;

FIG. 8 is a screen capture illustrating a sixth case where Lᵤ is located inside a polygon P with user location(s) in accordance with an embodiment of the invention;

FIG. 9 is a screen capture illustrating a seventh case where the region of interest and the location of the viewer are the same in accordance with an embodiment of the invention;

FIG. 10 is a screen capture illustrating an eighth case where the region of interest and the location of viewer are the same and also exclude certain region of interest and viewers from that location in accordance with an embodiment of the invention;

FIG. 11 is a screen capture illustrating a ninth case where the region of interest is excluded and the same location of viewer are excluded in accordance with an embodiment of the invention; and,

FIG. 12 is a screen capture illustrating a tenth case where there can be combinations of selection tests in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems, mobile devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

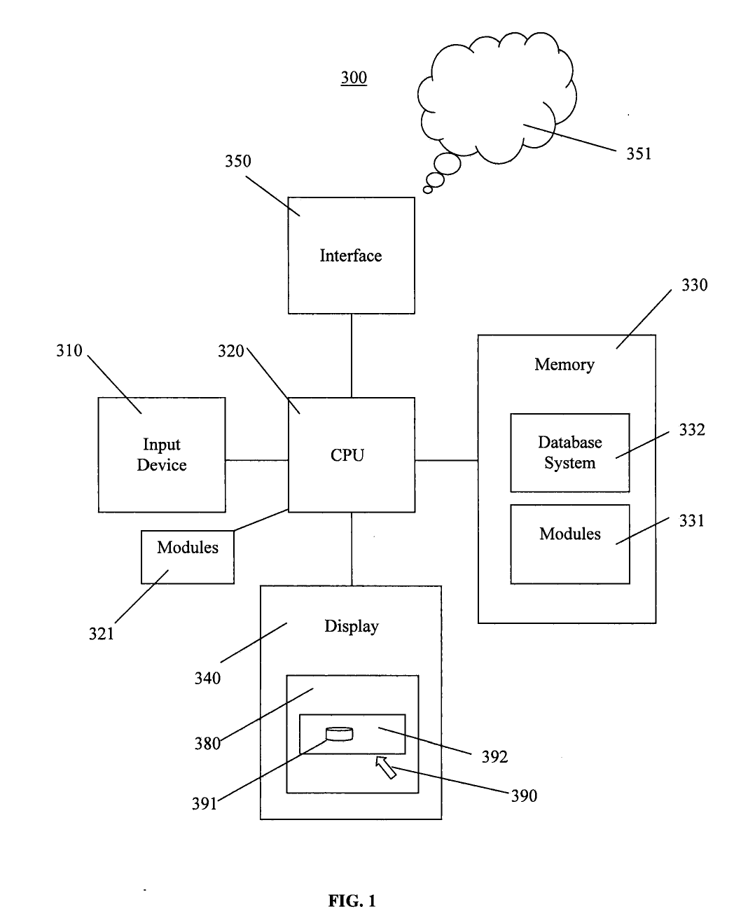

FIG. 1 is a block diagram illustrating a data processing system 300 in accordance with an embodiment of the invention. The data processing system 300 is suitable for generating, displaying, and adjusting presentations in conjunction with a graphical user interface (“GUI”), as described below. The data processing system 300 may be a client and/or server in a client/server system. For example, the data processing system 300 may be a server system or a personal computer (“PC”) system. The data processing system 300 may also be a mobile device or other wireless, portable, or handheld device. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. In addition, the data processing system 300 may include a Global Positioning System (“GPS”) receiver. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 (or store) for storing data and programming information. The database system 332 may include a database management system and a database and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium (or product) (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium (or product) that is uploaded to a network 351 by a vendor or supplier of the programmed instructions, and this signal or signal-bearing medium may be downloaded through an interface (e.g., 350) to the data processing system 300 from the network 351 by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

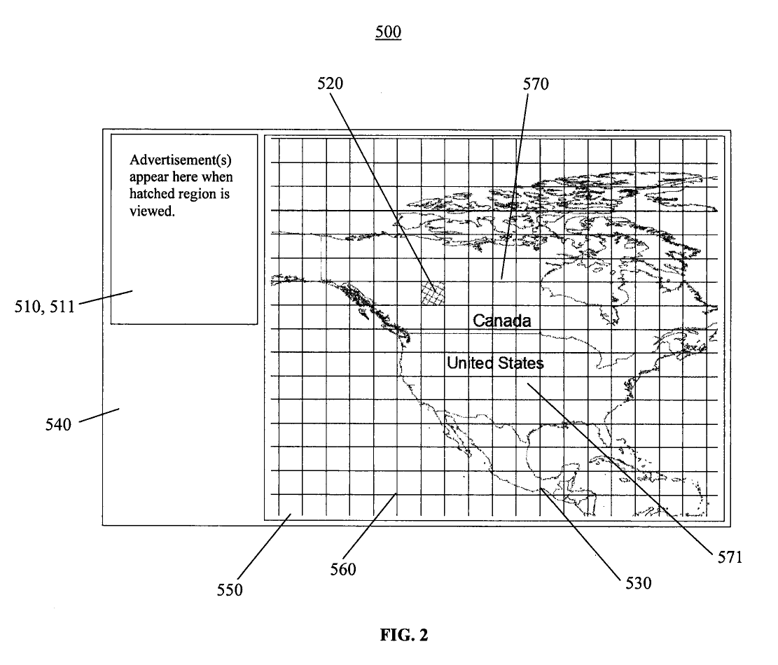

FIG. 2 is a screen capture illustrating an advertisement presentation 500 in accordance with an embodiment of the invention. FIG. 2 may be used to illustrate a method for geographically-based online advertising in accordance with an embodiment of the invention. Referring to FIG. 2, an advertiser may pay to have an advertisement 510 (or advertisements 510, 511) appear when a user later views a region or area 520 (shown as hatched in FIG. 2) on a map 530. According to one embodiment, prior to the user seeing this presentation 500, persons or corporations (i.e., advertisers) wishing to purchase space for advertisement presentation purchase from an advertising host or vendor the right or service of having a specific advertisement 510 appear when a given geographic region (i.e., a region-of-interest) or area 520 on a map 530 is later viewed, either in whole or in part, by a user on the user's display screen 340. Then, when the user later views the area or region 520, the advertisement 510 is presented in the presentation 500. According to one embodiment, the advertisement 510 may appear in a separate advertisement view or window 540 as shown in FIG. 2. According to another embodiment, the advertisement 510 may be presented using a window, overlay, or transparency over the map 530 in the map view or window 550. According to another embodiment, other means of advertisement presentation may be used.

According to one embodiment, an advertising vendor or host may sell advertising services (e.g., 510) to one or more advertisers for one or more geographic areas or regions (e.g., 520). In this embodiment, a map such as a world map or country map (e.g., 530) may be subdivided into a grid 560 and advertising services may be sold for presenting advertisements (e.g., 510) with respect to each unit (e.g., 520) of the grid 560. According to another embodiment, the advertising vendor may sell advertising services on the basis of coverage of a specific (or predetermined) geographic area such as a city, state, province, or country (e.g., Canada 570, the United States 571, etc.). According to another embodiment, the advertising services offered for sale may be sold on a temporal as well as a geographic basis. For example, an advertiser may purchase from the advertising vendor an advertising service providing for the display of a particular advertisement (e.g., 510) for a particular period of time (e.g., a prime Internet usage period, a weekday, a month, etc.). The advertising services would pertain to a particular geographic area or region (e.g., 520, 570, 571) and appropriate advertisements (e.g., 510, 511) would be presented when a user (i.e., a customer of the advertiser) views the particular geographic area or region (i.e., a region-of-interest to the user). When the user views the particular geographic area or region, the advertisement(s) 510, 511 may be presented to the user either in a main map view or window 550, advertisement view or window 540, or when (or within) the extent of an inset magnifier or a detail-in-context lens presented to the user on the user's display screen 340 intersects (or is positioned over) that area or region 520, 570, 571.

Now, as mentioned above, the growth of the Internet and online map presentation technologies has resulted in broad availability of online and interactive presentation of maps and geographically relevant photographic images. A complementary trend has been growing availability of portable implementations of locating technologies via mobile Global Positioning System (“GPS”) capabilities and network-assisted GPS in modern mobile devices and telephones. Furthermore, in many cases of Internet usage, a user's location can be established to varying degrees of confidence by other means such as Internet Protocol (“IP”) to location lookup. In addition, other location or location-related information may be known about a given user, such as home or office location, based on user profile in the case of a logged-in user or from Internet service provider records. The end result is a rich set of data related to multiple locations for any given Internet user and Internet usage session, including one or more locations of interest to the user (as expressed, for example, by a current map view requested by the user) as well as the actual location of the user himself and other locations related to the user (e.g., home address, office address, etc.). However, applications running on current data processing systems (e.g., mobile devices, etc.) have yet to take full advantage of available positioning technology to select information for presentation to users based on location.

According to the present invention, such locations and locations of interest are considered to fall within or outside geographic regions such as cities, states, and countries with polygonal boundaries. The rich set of location, location of interest, and location-related information available, considered in reference to these polygons and in specific combinations, may form the basis for decision-making with respect to which information to present to the user. Such decisions may include, for example: the choice of which news to show, in the case of an online news or weather or personal interest website; the selection of online advertising to present to the user; or, in a healthcare system, the basis for monitoring and alerting both users and healthcare providers of immediate or imminent health issues of concern, such as disease outbreaks and disease propagation.

According to the present invention, specific combinations of available location information are used in making particular information selection decisions, as described below.

In the following, the following location definitions are used each of which may, for example, be represented as longitude and latitude values or street addresses:
Lᵤ is the location of the user. Some uncertainty and inaccuracy may be associated with this location due to the methods used to obtain it (e.g., GPS precision limitations, IP to location limitations, etc.);
Lᵢ is the location of interest to the user. This location might be obtained, for example, from the map view that the user is looking at, for example, from the center point of the map view or other points of interest on the map, or from locations inferred from news article content;
Lₕ is the location of the home of the user;
L_{w} is the location of the place of work of the user; and,
P, P1, P2, and P3 are distinct polygons of interest.

In some circumstances, the above locations may be coincident. Lᵤ and Lᵢ are commonly time-varying in some cases of interest. The following cases now will be considered, beginning with some simpler situations, and then some more complex scenarios. Examples specific to selection of online advertisements (e.g., 510, 511) are provided, but selection of other content to be presented other than advertising is also possible.

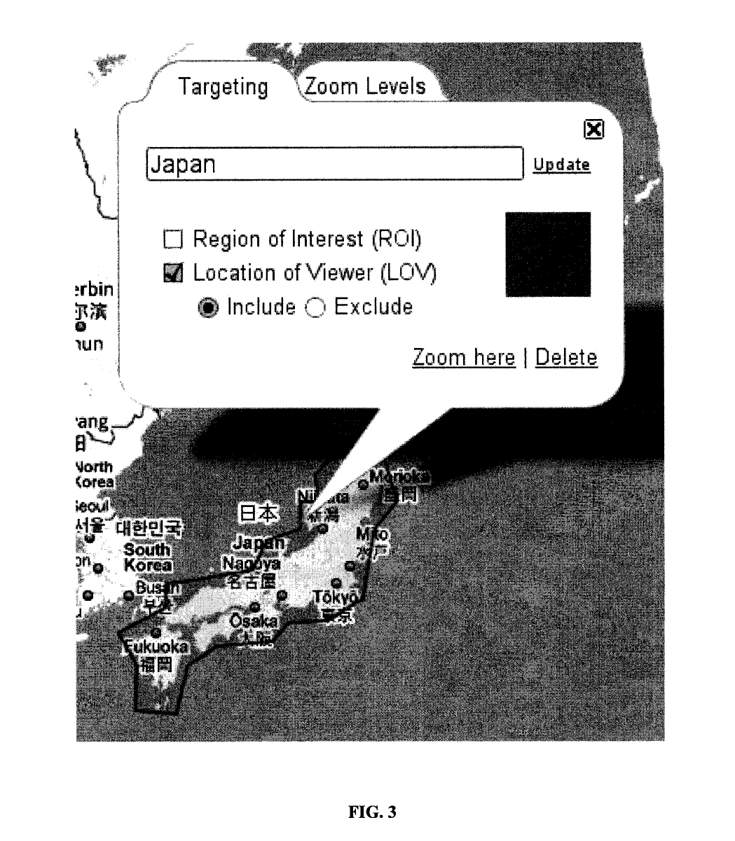

FIG. 3 is a screen capture illustrating a first case where Lᵤ is located inside a polygon P in accordance with an embodiment of the invention. In this first case, Lᵤ is located inside a polygon P. In this case, information is selected to be presented based on the location of the user falling within a defined polygon. For example, if Lᵤ is inside a particular polygon P representing a city, news related to that city, or an advertisement (e.g., 510, 511) of a business with interest in customers located in that city may be presented. Advertising examples for this case may include: target ads to all users from Japan (e.g., Japanese Restaurant); target ads in Japanese to all users who live in Japan; and, target ads local to user.

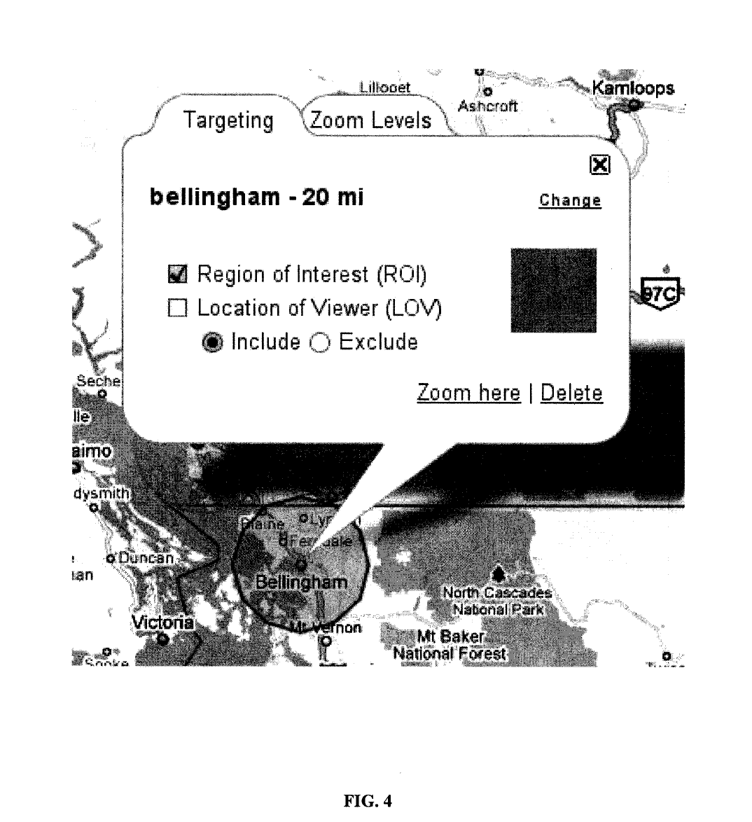

FIG. 4 is a screen capture illustrating a second case where Lᵢ is located inside a polygon P in accordance with an embodiment of the invention. In this second case, where Lᵢ is located inside a polygon P. In this case, information is selected to be presented based on a user's expression of interest in a location falling within a defined polygon. For example, if Lᵢ is inside a particular polygon P representing a city, news related to that city, or an advertisement (e.g., 510, 511) of a business with interest in customers located in that city, may be presented. Further refinement of the information to be displayed can be made based on known demographic or geographic characterization of the area in P, such as income level of the residents, or geographic entities in P such as lakes, parks, or mountains. In FIG. 4, the shaded area represents the polygon P.

In an online advertising context, the following advertising selection and display decisions are examples for this case: show ad if user is looking at locations where the business resides (e.g., Costco™ in Vancouver, Yale Town, Burnaby, Edmonton Mall, etc.); show ad if user is looking at locations where a deal exists (e.g., a British Airways™ flight special from Vancouver to London or Seattle to London); show ad if area income level is greater than X amount (e.g., BMW™ car ads, maid service, first class flight service, etc.); and, show ad if viewer is looking at a park or lake (e.g., ads for campers, boats, tents, etc.).

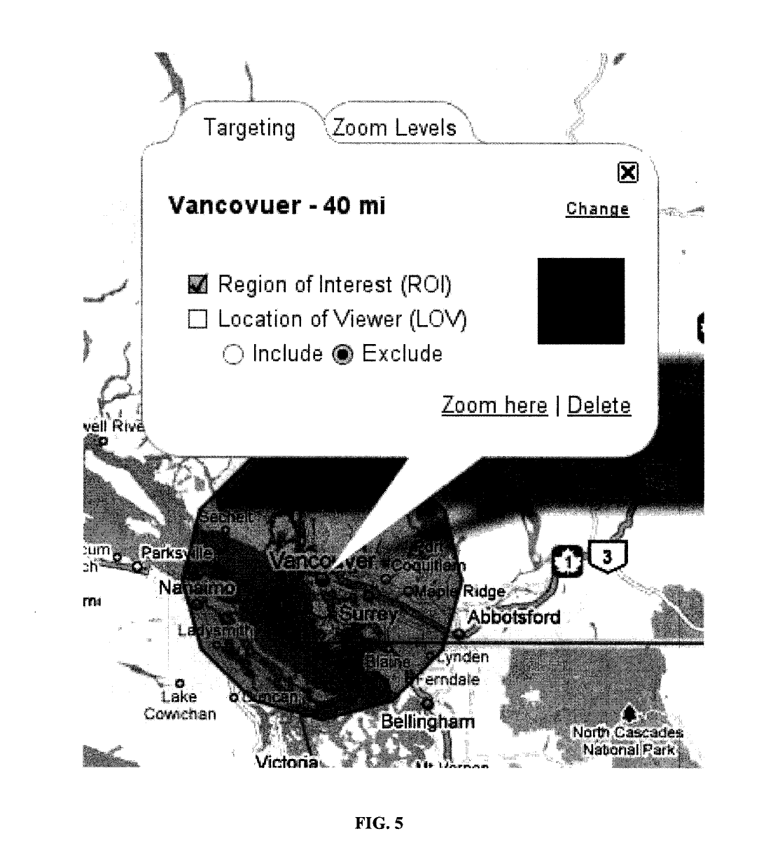

FIG. 5 is a screen capture illustrating a third case where Lᵢ is located outside a polygon P in accordance with an embodiment of the invention. In this third case, Lᵢ is located outside a polygon P. Advertising examples for this case may include the following: target ad to those looking outside Vancouver (e.g., Nanaimo Bars (Vancouverites already know about them, but the rest of the world may not)); target ad everywhere except for cold climates (e.g., sunscreen ad); and, target ad everywhere except areas populated by the elderly (e.g., surf board ad).

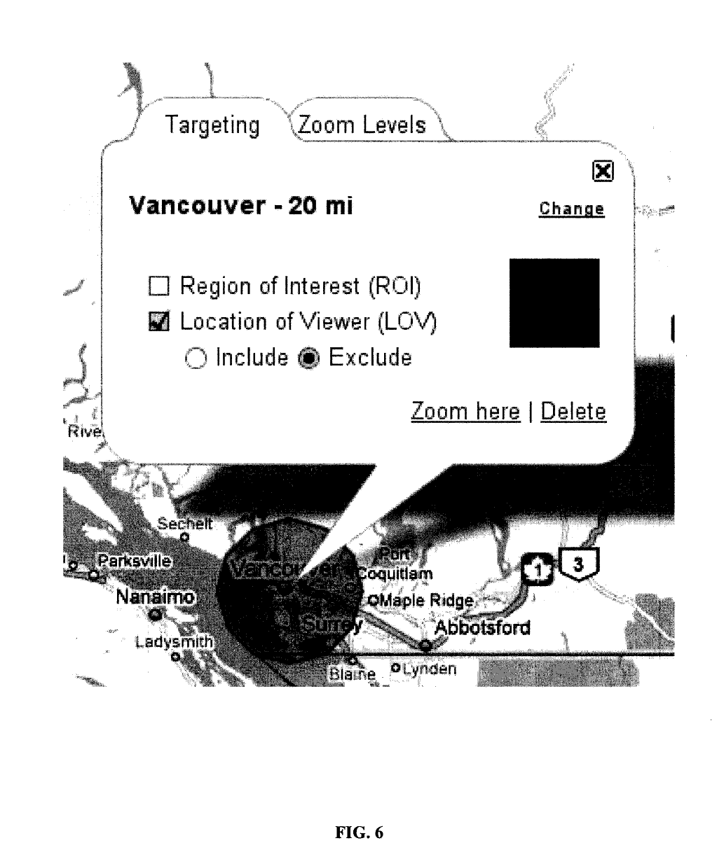

FIG. 6 is a screen capture illustrating a fourth case where Lᵤ is located outside a polygon Pin accordance with an embodiment of the invention. In this fourth case, Lᵤ is located outside a polygon P. Advertising examples for this case may include the following: target ad to all viewers who do not live in major cities (e.g., truck ads for those who live in the suburbs, farming equipment, etc.).

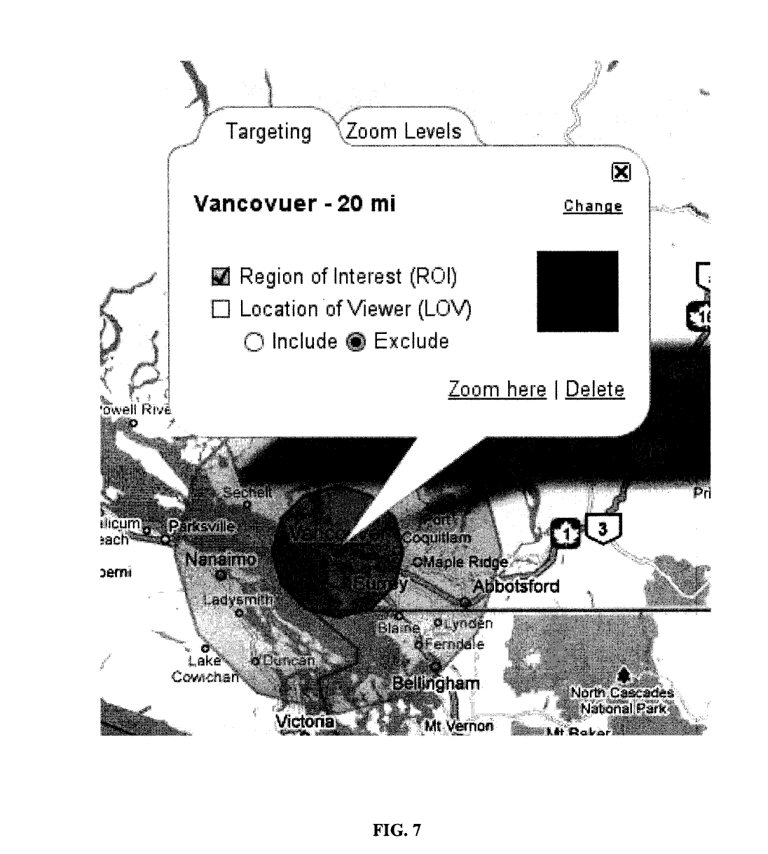

FIG. 7 is a screen capture illustrating a fifth case where Lᵢ is located inside a polygon P with excluded areas in accordance with an embodiment of the invention. In this fifth case, Lᵢ is located inside a polygon P with excluded areas. In this case, one targets a region area of interest but does not include a region within it or outside it. Advertising examples for this case may include the following: target ad to viewers looking around Vancouver, but not looking directly in the city (e.g., Translink™, fruit picking (i.e., farms are generally located outside the city), etc.).

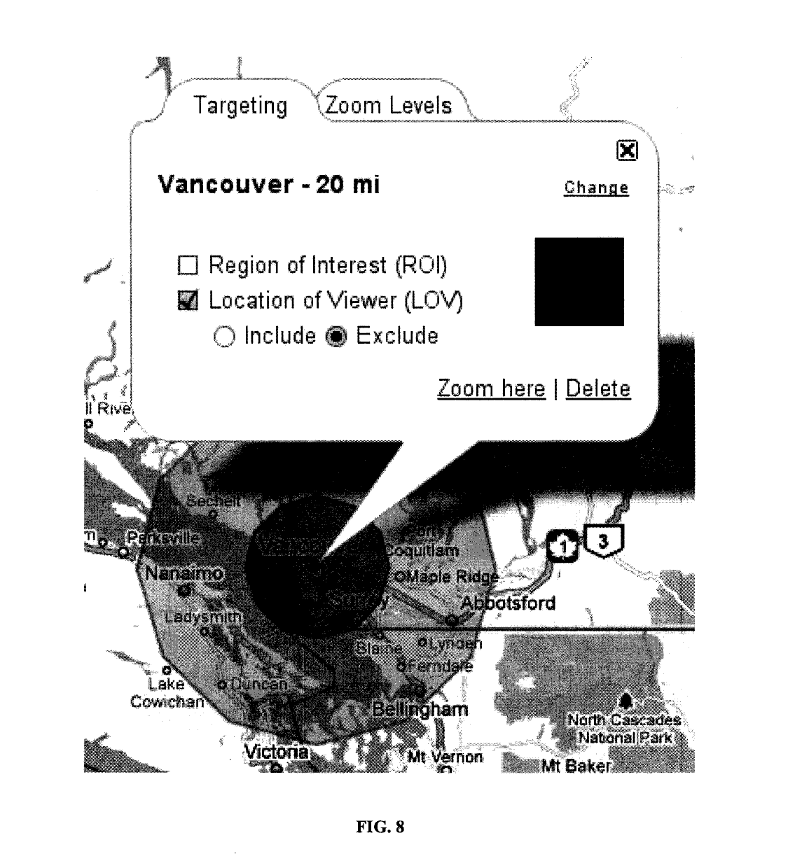

FIG. 8 is a screen capture illustrating a sixth case where Lᵤ is located inside a polygon P with excluded user location(s) in accordance with an embodiment of the invention. In this sixth case, Lᵤ is located inside a polygon P with excluded user location(s). In this case, one targets ads to all users who are located in an area and exclude those who are located in other areas. Advertising examples for this case may include the following: target ad to all viewers from Greater Vancouver but not those within Vancouver (i.e., downtown).

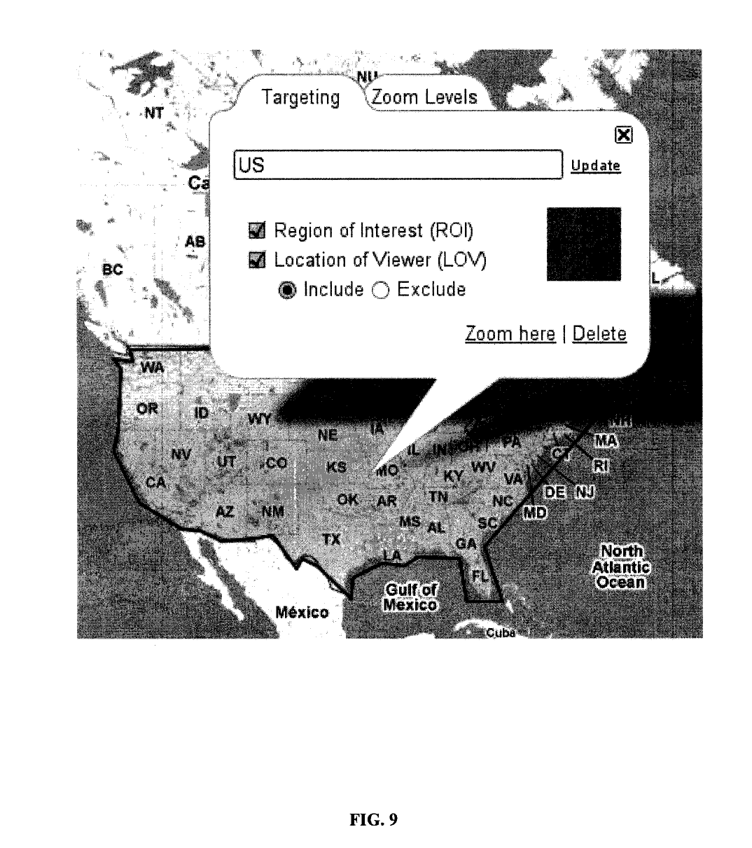

FIG. 9 is a screen capture illustrating a seventh case where the region of interest and the location of the viewer are the same in accordance with an embodiment of the invention. In this seventh case, the region of interest and the location of the viewer are the same. In this case, one targets ads to users for which both the region of interest and location of the view(er) are the same. In this case, one may target the ad to a mobile device user based on where the user currently is and where the user is looking (i.e., on his/her mobile device). Advertising examples for this case may include the following: target ad to all viewers from the US and who also live in the US (e.g., advertiser may not deliver product outside the US); and, coupon based ads that can be used immediately by a mobile device user.

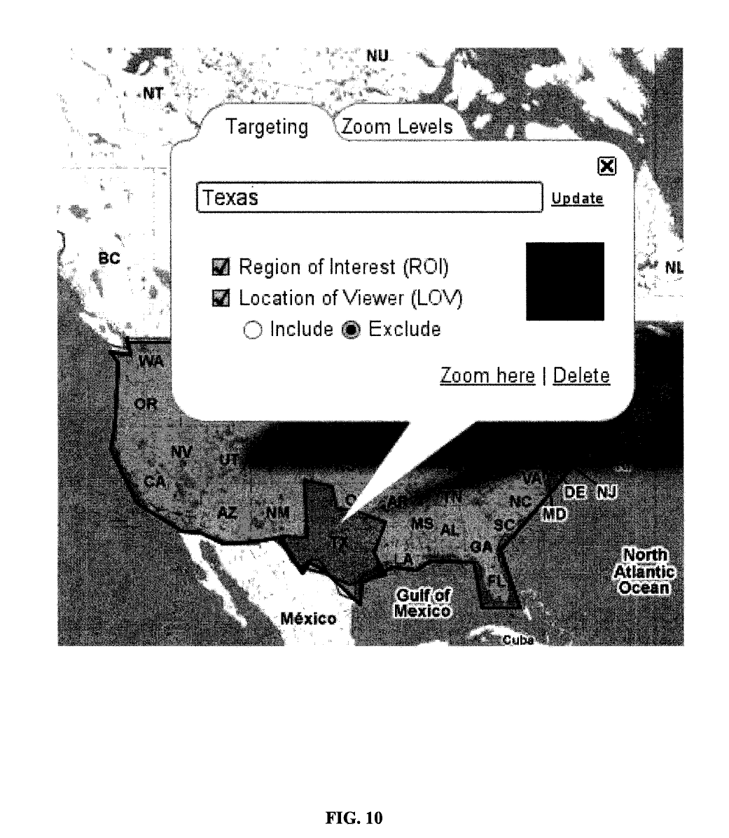

FIG. 10 is a screen capture illustrating an eighth case where the region of interest and the location of viewer are the same and also exclude certain region(s) of interest and viewers from that location in accordance with an embodiment of the invention. In this eighth case, the region of interest and the location of viewer are the same and also exclude certain region(s) of interest and viewers from that location. In this case, one targets ads where both the region of interest and location of the view(er) are the same but have a hole within or outside. In this case, one targets the ad to where the user is currently, but not the immediate vicinity (i.e., a “doughnut”-shaped selection). Advertising examples for this case may include the following: target ad to all viewers from the US and who live in the US, but not if the user is looking in Texas or living in Texas (e.g., because applicable laws are different in Texas); target Amazon™ ad to all states and from states except those in New Jersey because Amazon Books™ is pulling out of that state due to tax laws; and, coupon based ad that lures a user out of a current region to a competitor's store nearby.

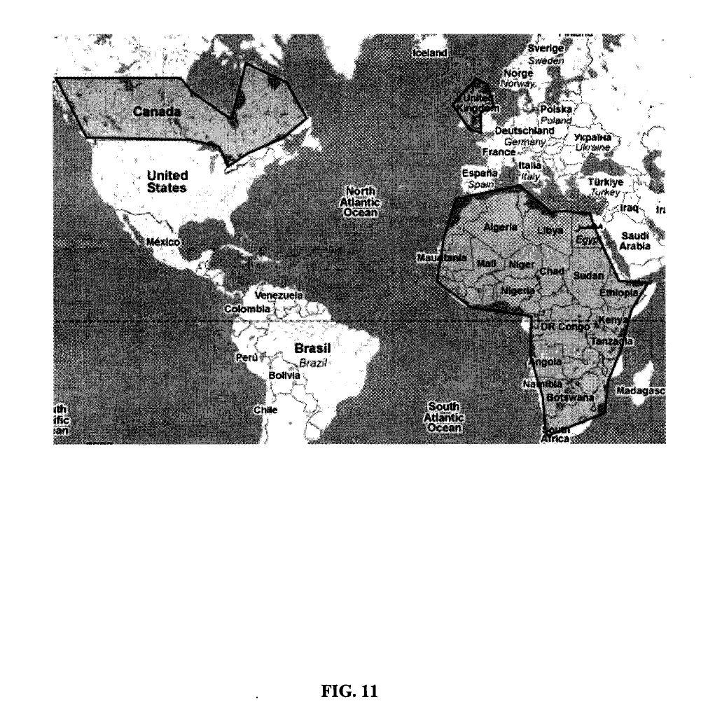

FIG. 11 is a screen capture illustrating a ninth case where the region of interest is excluded and the same location of viewer are excluded in accordance with an embodiment of the invention. In this ninth case, the region of interest is excluded and the same location of viewer are excluded. In this case, target ads where the viewer location and same region are excluded. This means that the viewer is looking in an area where they are not from. Advertising examples for this case may include the following: sightseeing ads; hotel ads; travel ads; right hand driving vs. left hand driving countries; and, drugs approved in all countries except Canada, UK, and Africa.

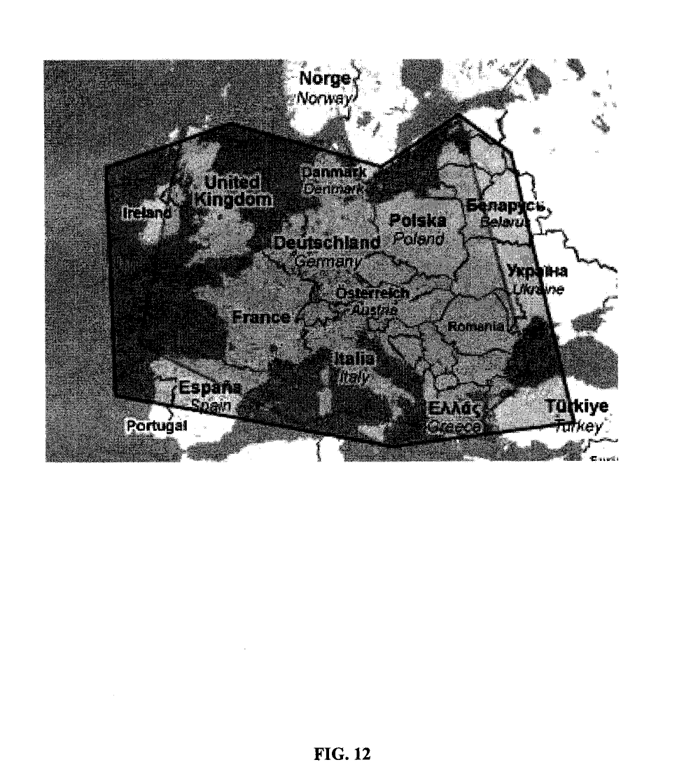

FIG. 12 is a screen capture illustrating a tenth case where there can be combinations of selection tests in accordance with an embodiment of the invention. In this tenth case, there can be any number of polygon inclusion/exclusion tests on Lᵢ and any number of polygon inclusion/exclusion tests on Lᵤ, and mixed combinations. For example, one can target an ad to someone who is looking in Europe, but does not live in Europe. For example, the Euro-rail pass is only available to travelers in Europe who are not from Europe.

In an eleventh case in accordance with an embodiment of the invention, distance metrics and hybrids of distance metrics and point-in-polygon inclusion and exclusion may be used for information selection. In this case, the distance between Lᵢ and Lᵤ may be used for information selection. For example, one may target ads to all of the US (Lᵤ in US) but only if the distance between Lᵢ and Lᵤ is greater than 500 km. For example, if the user is from Chicago and is looking in Seattle, the distance between Lᵢ and Lᵤ is greater than 500 km so, for example, a hotel ad or weekend get-away ad may be shown. If the user is from Everett and is looking in Seattle, |Lᵢ−Lᵤ|<500 km so the hotel ad or weekend get-away ad would not be shown.

In a twelfth case in accordance with an embodiment of the invention, work address and home address may be used for information selection. In all of the above cases (i.e., the first through eleventh cases), the work address or home address of the user, L_{w} or Lₕ, respectively, can be substituted for either or both Lᵤ or Lᵢ when these addresses are known. According to one embodiment, more complex combinations involving the presence of two or more of L_{w}, Lₕ, Lᵤ, and Lᵢ inside multiple polygons may also be used as bases for information presentation selection.

According to one embodiment, as shown in FIGS. 3-10, information selection parameters may be selected using a graphical user interface (“GUI”). The GUI may take the form of a pop-up window or otherwise. The pop-up window may have multiple tabs for selecting targeting parameters (“Targeting”) and for adjusting zoom levels for the presentation (“Zoom Levels”). The GUI may include a dialog box or other means for selecting or defining polygons P, P1, P2, P3. The GUI may include check boxes for selecting a “Region of Interest (ROI)” parameter (or Lᵢ) and/or a “Location of Viewer (LOV)” parameter (or Lᵤ). The GUI may include radio buttons (“Include” and “Exclude”) for selecting where to include or exclude information. And, the GUI may include a legend to display a color or shade associated with a given selection of parameters. This color or shade may also be shown in the map display.

Thus, according to one embodiment (e.g., FIG. 4), there is provided a method for presenting advertisement images 510, 511 on a display screen 340, comprising: subdividing a map image 530 into a plurality of geographic regions (e.g., 520); associating an advertisement image (e.g., 510) with a region (e.g., 520) of the plurality of geographic regions 520; receiving a signal indicative of a group of regions P (e.g., 520) of the plurality of geographic regions 520; receiving a signal indicative of a region-of-interest Lᵢ (e.g., 520), the region-of-interest Lᵢ corresponding to at least one region (e.g., 520) of the plurality of geographic regions 520; determining whether the region 520 and the region-of-interest Lᵢ are included in the group of regions P, and if so, generating a presentation (e.g., 500) of the advertisement image 510; and, displaying the presentation 500 on the display screen 340. In the above method, the group of regions P may be defined by at least one polygon P presented on the map image 530.

While this invention is primarily discussed as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product according to one embodiment of the invention. This computer software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for presenting advertisement images on a display screen, comprising:
subdividing a map image into a plurality of geographic regions;
associating an advertisement image with a region of the plurality of geographic regions;
receiving a signal indicative of a group of regions of the plurality of geographic regions;
receiving a signal indicative of a region-of-interest, the region-of-interest corresponding to at least one region of the plurality of geographic regions;
determining whether the region and the region-of-interest are included in the group of regions, and if so, generating a presentation of the advertisement image; and,
displaying the presentation on the display screen.

2. The method of claim 1 wherein the group of regions is defined by at least one polygon presented on the map image.
